(19) United States
(12) Patent Application Publication
(10) Pub. No.: US 2007/0227475 A1
(43) Pub. Date: Oct. 4, 2007

(54) INTERNAL COMBUSTION ENGINE AND TRANSPORATION APPARATUS INCORPORATING THE SAME

(75) Inventors: Yasuhiro HIRAMITSU, Shizuoka (JP); Toshikatsu KOIKE, Shizuoka (JP); Junichi INAMI, Shizuoka (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(73) Assignee: YAMAHA HATSUDOKI KABUSHIKI KAISHA, Iwata-shi (JP)

(21) Appl. No.: 11/689,615

(22) Filed: Mar. 22, 2007

(30) Foreign Application Priority Data
Mar. 28, 2006 (JP) 2006-087377

(51) Int. Cl. F02F 1/10; F02F 1/00

(52) U.S. Cl. 123/41.72; 123/193.2

(57) ABSTRACT

An internal combustion engine includes a cylinder block formed of a metal material, a cylinder liner formed of a metal material different from that of the cylinder block, the cylinder liner being fitted onto the cylinder block, a water jacket provided between the cylinder block and the cylinder liner for retaining a coolant, and a sealing member provided in contact with the cylinder block and the cylinder liner, the sealing member preventing leakage of the coolant from the water jacket. The cylinder block and the cylinder liner have respective positioning surfaces, each of which determines a relative position against the other. The positioning surfaces are provided on the opposite side of the sealing member from the water jacket. The cylinder block and the cylinder liner are spaced apart from each other, in between the sealing member and the water jacket.

### BACKGROUND OF THE INVENTION

1. Field of the Invention

The present invention relates to an internal combustion engine, and in particular, to a water-cooling type internal combustion engine in which a cylinder block and a cylinder liner are formed of different metal materials. Moreover, the present invention relates also to a transportation apparatus incorporating such an internal combustion engine.

2. Description of the Related Art

Currently, internal combustion engines are used as motive power sources for various transportation apparatuses. In the interior of a cylinder block, which is a fundamental part of an internal combustion engine, a piston moves up and down (reciprocates) very rapidly. Therefore, the cylinder block is required to have a high abrasion resistance. Accordingly, in order to improve the abrasion resistance of the cylinder block, it is common practice to fit a cylinder liner onto a cylinder block.

FIG. 12 shows an example of cylinder block for a conventional water-cooling type internal combustion engine (disclosed in Japanese Laid-Open Patent Publication No. 2004-116481). A cylinder liner 520 is fitted onto the cylinder block 510 shown in FIG. 12 so as to cover the inner peripheral surface thereof. Between an inner wall 510a and an outer wall 510b of the cylinder block 510, a space (referred to as a “water jacket”) 540 for retaining a coolant is provided. An upper end (i.e., the end closer to the cylinder head) of the water jacket 540 is closed with a closing member 510c.

The cylinder block 510 and the cylinder liner 520 are formed of different metal materials. Specifically, the cylinder liner 520 is formed of a metal material having a higher abrasion resistance than that of a metal material composing the cylinder block 510. Since the cylinder liner 520 is fitted, the cylinder block 510 itself does not come in direct contact with a piston so that the abrasion thereof is prevented.

In the cylinder block 510 shown in FIG. 12, the water jacket 540 is surrounded by inner wall 510a and the outer wall 510b of the cylinder block 510 and the closing member 510c. Therefore, the cylinder liner 520 does not come in direct contact with the cooling water which is retained within the water jacket 540. Such a cylinder liner 520 is referred to as a “dry liner”.

On the other hand, cylinder liners which are arranged so as to come in direct contact with cooling water, referred to as “wet liners”, are also known. FIG. 13 shows an example of a cylinder block in which a wet liner is provided (disclosed in Japanese laid-open patent publication no. 2004-263605).

A cylinder block 610 shown in FIG. 13 is formed integrally with a crankcase 630 which accommodates a crankshaft. On the cylinder block 610, a cylinder liner 620 having a flange portion 620F, which is in the form of a brim, is fitted. The cylinder block 610 is constricted so as to be capable of supporting the flange portion 620F of the cylinder liner 620.

In the example shown in FIG. 13, a space 640 between the cylinder liner 620 and the cylinder block 610 functions as a water jacket. In the constricted portion of the cylinder block 610, O-rings 650 for preventing leakage of the coolant from the water jacket 640 are provided.

In the wet liner method as shown in FIG. 13, the cylinder liner 620 comes in direct contact with the coolant, and therefore, it is easier to cool the cylinder liner 620 than in the dry liner method as shown in FIG. 12. Moreover, unlike in the dry liner method, it is not necessary to form both the inner wall 510a and the outer wall 510b in the cylinder block 510. Therefore, the cylinder block 610 can be made thin, thus allowing for mass reduction.

However, in the wet liner method, since the cylinder liner 620 and the cylinder block 610 are formed of different metal materials and an electrolyte solution (which also encompasses water alone) exists between them, bimetallic contact corrosion (also referred to as galvanic corrosion or local current corrosion; hereinafter simply referred to as “electrolytic corrosion”) may occur. This electrolytic corrosion is attributable to the fact that a kind of battery is formed due to a difference in ionization tendency between the metal composing the cylinder liner 620 and the metal composing the cylinder block 610.

It might be conceivable to paint the surfaces of the cylinder liner 620 and the cylinder block 610 in order to prevent electrolytic corrosion. However, painting would induce a decrease in dimensional precision, such that the cylinder block 610 and the cylinder liner 620 might not be fitted together with a high precision. If the fitting precision between the cylinder block 610 and the cylinder liner 620 is lowered, the sliding motion of the piston may be hindered, and it may become impossible to maintain airtightness or sealing ability.

### SUMMARY OF THE INVENTION

In order to overcome the aforementioned problems, preferred embodiments of the present invention provide an internal combustion engine of a wet liner type in which a cylinder block and a cylinder liner that are formed of respectively different metal materials are fitted together with a high precision, and in which electrolytic corrosion is suppressed; and a transportation apparatus incorporating the same.

An internal combustion engine according to a preferred embodiment of the present invention includes a cylinder block formed of a metal material; a cylinder liner formed of a metal material different from that of the cylinder block, the cylinder liner being fitted onto the cylinder block; a water jacket provided between the cylinder block and the cylinder liner for retaining a coolant; and a sealing member provided in contact with the cylinder block and the cylinder liner, the sealing member preventing leakage of the coolant from the water jacket, wherein, the cylinder block and the cylinder liner have respective positioning surfaces, each of which determines a relative position against the other; each positioning surface is provided on an opposite side of the sealing member from the water jacket; and the cylinder block and the cylinder liner are spaced apart from each other, in between the sealing member and the water jacket.

In a preferred embodiment, the cylinder block and/or the cylinder liner have a coated surface on an opposite side of the sealing member from the positioning surfaces, the coated surface being covered with a coating.

In a preferred embodiment, between the sealing member and the water jacket, the cylinder block and the cylinder liner are spaced apart by a gap or space of about 1 μm or more.

In a preferred embodiment, the cylinder block or the cylinder liner has a seal surface having a seal groove for holding the sealing member.

In a preferred embodiment, between the sealing member and the water jacket, the cylinder block and the cylinder liner are spaced apart by a gap or space of about 0.5 D or less, where D is a depth of the seal groove.

In a preferred embodiment, a portion of the positioning surface is located within the seal surface.

In a preferred embodiment, the positioning surfaces of the cylinder block and the cylinder liner include portions extending in a direction substantially parallel to a cylinder axis; and a fitting tolerance between the portions extending in the direction substantially parallel to the cylinder axis is preferably about 50 μm or less.

In a preferred embodiment, the internal combustion engine according to the present invention further includes a crankcase, wherein, the crankcase is a separate piece from the cylinder liner.

In a preferred embodiment, the internal combustion engine according to the present invention further includes a crankcase, wherein, the crankcase is a separate piece from the cylinder block.

In a preferred embodiment, a side surface of the cylinder liner facing the water jacket has a tapered shape.

In a preferred embodiment, the sealing member is an O-ring having a durometer hardness (HDA) of no less than about 65 and no more than about 75.

In a preferred embodiment, the metal material composing the cylinder block has a smaller specific gravity than that of the metal material composing the cylinder liner.

In a preferred embodiment, the internal combustion engine according to the present invention further includes a cylinder head provided above the cylinder block and the cylinder liner via a gasket, the cylinder head being fastened to the cylinder block, wherein, a stress applied from the cylinder head to the cylinder block is smaller than a stress applied from the cylinder head to the cylinder liner.

A transportation apparatus according to another preferred embodiment of the present invention includes an internal combustion engine having the above-described unique construction.

A cylinder block and a cylinder liner of the internal combustion engine according to various preferred embodiments of the present invention have respective positioning surfaces, each of which determines a relative position against the other, the positioning surfaces being provided on the opposite side of the sealing member from the water jacket. In other words, the sealing member is located between the positioning surfaces and the water jacket. As a result, the coolant will not flow between the positioning surface of the cylinder block and the positioning surface of the cylinder liner, whereby electrolytic corrosion is prevented. Therefore, it is not necessary to provide a coating for preventing electrolytic corrosion on the positioning surfaces, which are required to have highly precise dimensions, and thus the cylinder block and the cylinder liner can be fitted together with a high precision. On the other hand, the portions of the surfaces of the cylinder block and the cylinder liner that surround the water jacket are in direct contact with the coolant. However, these portions are not required to have as high a dimensional precision as is required of the positioning surfaces. Therefore, electrolytic corrosion in these portions can be prevented by forming a coating (e.g., painting). Thus, according to various preferred embodiments of the present invention, the cylinder block and the cylinder liner formed of respectively different metal materials can be fitted together with a high precision, while suppressing electrolytic corrosion.

Moreover, the cylinder block and the cylinder liner of the internal combustion engine according to various preferred embodiments of the present invention are spaced apart from each other, in between the sealing member and the water jacket. Therefore, even in the case where a coating is formed as mentioned above, the coating is prevented from coming into contact with opposing members, so that peeling of the coating due to vibrations during operation and peeling of the coating during press-fitting of the cylinder liner can be prevented. As a result, according to various preferred embodiments of the present invention, electrolytic corrosion can be advantageously suppressed for long periods of time.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view schematically showing an internal combustion engine 100 according to a preferred embodiment of the present invention.

FIG. 2 is an enlarged cross-sectional view showing a portion of the cross-sectional structure of the internal combustion engine 100 shown in FIG. 1.

FIG. 3 is an enlarged cross-sectional view showing a portion of the cross-sectional structure of the internal combustion engine 100 shown in FIG. 1.

FIGS. 4A, 4B, and 4C are cross-sectional views showing modifications to the internal combustion engine 100 according to a preferred embodiment of the present invention.

FIG. 5 is a cross-sectional view showing a modification to the internal combustion engine 100 according to a preferred embodiment of the present invention.

FIG. 6 is a diagram showing a preferable shape of a cylinder liner.

FIG. 7 is a cross-sectional view showing an exemplary overall structure of the internal combustion engine 100 according to a preferred embodiment of the present invention.

FIG. 8 is a cross-sectional view schematically showing the internal combustion engine 100 according to a preferred embodiment of the present invention.

FIG. 9 is a cross-sectional view schematically showing the internal combustion engine 100 according to a preferred embodiment of the present invention.

FIG. 10 is a cross-sectional view schematically showing the internal combustion engine 100 according to a preferred embodiment of the present invention.

FIG. 11 is a side view schematically showing a motorcycle incorporating the internal combustion engine 100 shown in FIG. 7.

FIG. 12 is a cross-sectional view schematically showing a conventional cylinder block 510 for a water-cooling type internal combustion engine.

FIG. 13 is a cross-sectional view schematically showing a conventional cylinder block 610 for a water-cooling type internal combustion engine.

### DETAILED DESCRIPTION OF PREFERRED EMBODIMENTS

Hereinafter, preferred embodiments of the present invention will be described with reference to the accompanying drawings. Note that the present invention is not to be limited to the following preferred embodiments.

FIG. 1 schematically shows the cross-sectional structure of an internal combustion engine 100 according to the present preferred embodiment. In FIG. 1, only some of the component elements of the internal combustion engine 100 are illustrated for ease of description.

The internal combustion engine 100 preferably includes a cylinder block 10; a cylinder liner (also referred to as a cylinder sleeve) 20 which is fitted onto the cylinder block 10; and a crankcase 30 accommodating a crankshaft (not shown).

The cylinder block 10 and the cylinder liner 20 according to the present preferred embodiment are each preferably formed as a separate piece from the crankcase 30. A brim-like flange portion 20F is provided in the cylinder liner 20, the flange portion 20F being sandwiched between the cylinder block 10 and the crankcase 30. A cylinder head (not shown) is provided above the cylinder block 10 and the cylinder liner 20.

The cylinder block 10 and the cylinder liner 20 are formed of respectively different metal materials. The cylinder block 10 may be formed from a magnesium alloy by casting, for example. As the magnesium alloy, an alloy having a thermal resistance which is required of the cylinder block 10 is used. As specific examples, AE42 or AS21 for die casting, and QE22 or ZE41 for sand-mold casting can be used. Otherwise, a thermally-resistant aluminum alloy or resin can be used as the material of the cylinder block 10. The cylinder liner 20 may be formed from an aluminum alloy by die casting, for example. Specific examples of the aluminum alloy are ADC12 for die casting and AC4B for sand-mold casting. Otherwise, cast irons may be used as the material of the cylinder liner 20. The crankcase 30 and the cylinder head can be formed from an aluminum alloy such as ADC12, AC4B, or AC4C by die casting or casting, for example.

It will be appreciated that the materials of the cylinder block 10, the cylinder liner 20, the crankcase 30, and the cylinder head are not limited to those exemplified herein. However, it is preferable that the metal material composing the cylinder block 10 has a smaller specific gravity than that of the metal material composing the cylinder liner 20. By selecting a metal material having a smaller specific gravity than that of the metal material of the cylinder liner 20 as the metal material of the cylinder block 10, it becomes possible to reduce the mass of the internal combustion engine 100.

Aluminum alloys, in particular aluminum alloys containing silicon are suitable materials for the cylinder liner 20 because they are light-weight and have excellent abrasion resistance. Magnesium alloys have smaller specific gravities than those of aluminum alloys, and therefore are suitable materials for a light-weight cylinder block 10.

A water jacket 40 is provided between the cylinder block 10 and the cylinder liner 20. The water jacket 40 is a space which is surrounded by the cylinder block 10, the cylinder liner 20, and the cylinder head. The water jacket 40 is positioned around the cylinder liner 20, such that a coolant which is retained in the water jacket 40 allows the cylinder block 10 and the cylinder liner 20 to be cooled.

In order to prevent leakage of the coolant from the water jacket 40, a sealing member 50 is provided so as to be in contact with both of the cylinder block 10 and the cylinder liner 20. In the present preferred embodiment, a seal groove 11a is formed in a portion 11 of the surface of the cylinder block 10 facing the cylinder liner 20, such that the sealing member 50 is held by the seal groove 11a. In the present specification, the surface 11 on which the seal groove 11a is provided is referred to as the “seal surface”.

The sealing member 50 according to the present preferred embodiment is an O-ring. A rubber O-ring preferably has a durometer hardness (HDA) of no less than about 65 and no more than about 75. If the hardness of the O-ring is less than about 65, the O-ring will be too liable to deformation, thus resulting in a reduced watertightness of the water jacket 40. If the hardness of the O-ring exceeds about 75, the O-ring will be too difficult to deform, thus making it difficult to press fit the cylinder liner 20 into the cylinder block 10. The durometer hardness (HDA) of the O-ring should be a measurement value which is obtained by using a type-A durometer according to ISO7619, the value being a readout from within one second.

Assembly of the internal combustion engine 100 is performed by, for example, press fitting the flange portion 20F of the cylinder liner 20 into the cylinder block 10, and then press fitting the flange portion 20F of the cylinder liner 20 so as to fit within the crankcase 30. Further thereafter, a cylinder head is placed on the upper end surface of the cylinder block 10 and the cylinder liner 20 via a gasket (not shown) and is fastened with bolts, whereby the internal combustion engine 100 is obtained.

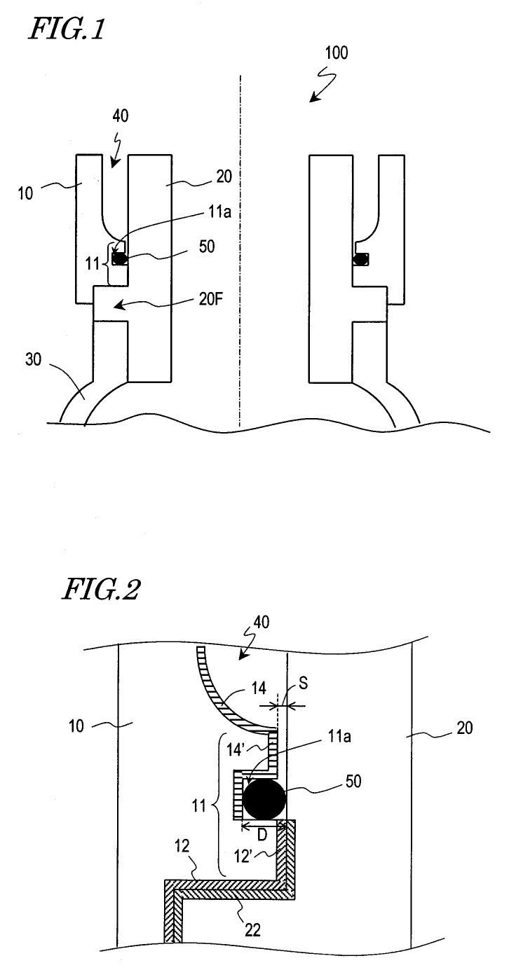

The internal combustion engine 100 according to the present preferred embodiment has a structure which is suitable for allowing the cylinder liner 20 and the cylinder block 10 to be fitted together with a high precision. With reference to FIG. 2, the structure of the internal combustion engine 100 will be described more specifically. FIG. 2 is an enlarged diagram showing the area of the flange portion 20F.

As shown in FIG. 2, the cylinder block 10 and the cylinder liner 20 have positioning surfaces 12 and 22, respectively, each of which determines a relative position against the other. In FIG. 2, the positioning surface 12 of the cylinder block 10 is shown hatched with lines ascending toward the right, whereas the positioning surface 22 of the cylinder liner 20 is shown hatched with lines ascending toward the left. As the positioning surface 12 of the cylinder block 10 and the positioning surface 22 of the cylinder liner 20 engage with each other, the position of the cylinder liner 20 with respect to the cylinder block 10 is determined.

As shown in FIG. 2, the positioning surfaces 12 and 22 are provided on the opposite side of the sealing member 50 from the water jacket 40. In other words, the sealing member 50 is located between the positioning surfaces 12 and 22 and the water jacket 40.

Moreover, the cylinder block 10 includes a coated surface 14 which is provided on the opposite side of the sealing member 50 from the positioning surface 12, the coated surface 14 being covered with a coating. In FIG. 2, the coated surface 14 is shown hatched with horizontal lines. The coated surface 14 is provided in a portion directly exposed to the coolant, whereby electrolytic corrosion is prevented. In order to sufficiently prevent electrolytic corrosion, it is preferable that a coating having a thickness of about 1 μm or more, for example, is formed on the coated surface 14.

The coated surface 14 may be a painted surface, for example. As the material of the painted membrane, an epoxy-type paint or a Teflon coating (rigid resin coating) having an excellent water resistance may be used, for example. Note that the technique for forming the coating is not limited to painting, but a surface treatment such as conversion treatment or anodic oxidation may instead be used.

As shown in FIG. 2, in between the sealing member 50 and the water jacket 40, the cylinder block 10 (including the coated surface 14) and the cylinder liner 20 are spaced apart from each other.

Note that a coated surface may be provided on the cylinder liner 20 by forming a coating on the cylinder liner 20, rather than on the cylinder block 10. However, since the cylinder liner 20 rises up to a higher temperature than does the cylinder block 10, it is preferable to provide the coated surface 14 on the cylinder block 20 from the standpoint of suppressing deterioration of the coating due to high temperature. Alternatively, coated surfaces may be provided on both of the cylinder block 10 and the cylinder liner 20.

A portion 12′ of the positioning surface 12 and a potion 14′ of the coated surface 14 are shown to be located within the seal surface 11 in the present preferred embodiment. However, it is not necessary that a portion of the positioning surface 12 be located within the seal surface 11.

In the internal combustion engine 100 according to the present preferred embodiment, as described above, the positioning surfaces 12 and 22 are provided on the opposite side of the sealing member 50 from the water jacket 40. In other words, the sealing member 50 is located between the positioning surfaces 12 and 22 and the water jacket 40. As a result, the coolant will not flow between the positioning surface 12 of the cylinder block 10 and the positioning surface 22 of the cylinder liner 20, whereby electrolytic corrosion is prevented. Therefore, it is not necessary to provide a painting for preventing electrolytic corrosion on the positioning surfaces 12 and 22, which are required to have highly precise dimensions, and thus the cylinder block 10 and the cylinder liner 20 can be fitted together with a high precision.

Of course, the portions of the surfaces of the cylinder block 10 and the cylinder liner 20 that surround the water jacket 40 are in direct contact with the coolant. However, these portions are not required to have as high a dimensional precision as is required of the positioning surfaces 12 and 22. Therefore, electrolytic corrosion in these portions can be prevented by forming a coating (e.g., painting) as is done in the present preferred embodiment.

Thus, according to preferred embodiments of the present invention, while suppressing electrolytic corrosion, the cylinder block 10 and the cylinder liner 20 formed of respectively different metal materials can be fitted together with a high precision. As a result, the efficiency of the sliding motion of the piston can be improved, and a sufficient airtightness and sealing ability can be obtained.

Moreover, according to the present preferred embodiment, the cylinder block 10 and the cylinder liner 20 are spaced apart from each other, between the sealing member 50 and the water jacket 40. Therefore, the coated surface 14 of the cylinder block 10 is prevented from coming into contact with the surface of the cylinder liner 20 due to vibrations during operation (or due to press-fitting of the cylinder liner 20) and resulting in a peeling of the coating. Therefore, according to preferred embodiments of the present invention, electrolytic corrosion can be advantageously suppressed for long periods of time.

Preferably, between the sealing member 50 and the water jacket 40, the cylinder block 10 and the cylinder liner 20 are spaced apart by a space or gap S of about 1 μm or more, for example (see FIG. 2). It is also preferable that the gap or space S is about 0.5D or less, where D is the depth of the seal groove 11a (see FIG. 2). Table 1 and Table 2 show a relationship between: the interspace S between the cylinder block 10 and the cylinder liner 20; the electrolytic corrosion prevention effect; and the sealing ability. In Table 1 and Table 2, “⊚” and “◯” both indicate a good electrolytic corrosion prevention effect or a good sealing ability, where “⊚” is better than “◯” (i.e., “⊚” indicates a very good electrolytic corrosion prevention effect or a very good sealing ability).

TABLE 1

| interspace S (μm) | | |
|---|---|---|
| between cylinder | electrolytic | |
| block and cylinder | corrosion | |
| liner | prevention | sealing ability |
| 1.3 | ⊚ | ⊚ |
| 1.2 | ⊚ | ⊚ |
| 1.1 | ⊚ | ⊚ |
| 1.0 | ⊚ | ⊚ |
| 0.9 | ◯ | ⊚ |
| 0.8 | ◯ | ⊚ |
| 0.7 | ◯ | ⊚ |
| 0.6 | ◯ | ⊚ |
| 0.5 | ◯ | ⊚ |

TABLE 2

| interspace S (μm) | | |
|---|---|---|
| between cylinder | electrolytic | |
| block and cylinder | corrosion | |
| liner | prevention | sealing ability |
| D × 0.52 | ⊚ | ◯ |
| D × 0.51 | ⊚ | ◯ |
| D × 0.50 | ⊚ | ⊚ |
| D × 0.49 | ⊚ | ⊚ |
| D × 0.48 | ⊚ | ⊚ |

As shown in Table 1, from the standpoint of preventing electrolytic corrosion with a greater certainty, it is preferable that the gap or space S is about 1 μm or more. This is because, when the gap or space S is about 1 μm or more, unwanted contact of the cylinder block 10 and the cylinder liner 20 in between the sealing member 50 and the water jacket 40 and consequent peeling of the coating can be prevented with a greater certainty.

As shown in Table 2, from the standpoint of providing an enhanced sealing ability, it is preferable that the gap or space S is about 0.5 D or less. This is because, if the gap or space S exceeds about 0.5 D (i.e., half of the depth D of the seal groove 11a), the sealing member 50 such as an O-ring may not be suitably held by the seal groove 11a, thus resulting in a reduced sealing ability.

The depth D of the seal groove 11a may be appropriately set in accordance with the type and specifications of the sealing member 50. In the case where the sealing member 50 is an O-ring, the depth D of the seal groove 11a is set to be about 0.56 times as large as the diameter d of the O-ring (i.e., D=0.56 d).

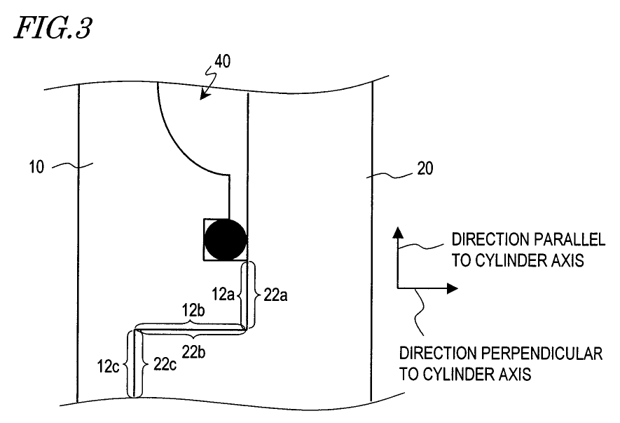

As is also shown in FIG. 3, the positioning surfaces 12 and 22 of the cylinder block 10 and the cylinder liner 20 include portions 12a, 12c, 22a, and 22c which extend in a direction substantially parallel to the cylinder axis (which is shown by a dot-dash line in FIG. 1). When the fitting tolerance between such portions is about 50 μm or less, there is a high effect of preventing misalignment between the cylinder block 10 and the cylinder liner 20 along a direction that is substantially perpendicular to the cylinder axis, and a high effect of preventing peeling of the coating due to contact between the coated surface 14 and the cylinder liner 20 caused by vibrations during operation.

Moreover, the positioning surfaces 12 and 22 of the cylinder block 10 and the cylinder liner 20 include portions 12b and 22b which extend in a direction intersecting the cylinder axis (which herein is exemplified as a direction perpendicular to the cylinder axis). By reducing the tolerance for such portions as much as possible, there is provided an enhanced effect of preventing misalignment between the cylinder block 10 and the cylinder liner 20 along the direction parallel to the cylinder axis, and the relative height of the cylinder liner 20 with respect to the cylinder block 10 can be defined with a higher precision.

Note that conventional structures require a coating of about 30 μm to about 60 μm to be formed also on the positioning surface (in the case of painting) in order to prevent electrolytic corrosion, which makes it difficult to realize the aforementioned ranges of fitting tolerance and tolerance.

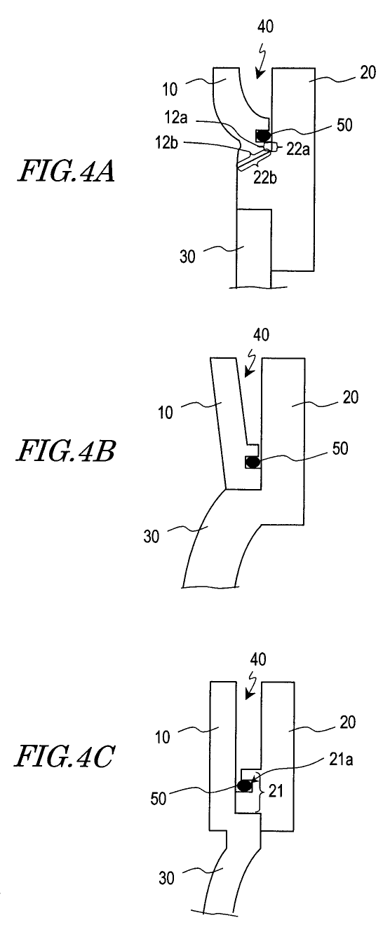

Now, with reference to FIGS. 4A, 4B, and 4C and FIG. 5, modifications to the internal combustion engine 100 according to the present preferred embodiment will be described.

In the internal combustion engine 100 according to the present preferred embodiment, a portion of the positioning surface 12 is located within the seal surface 11. As a result, the number of planes composing the positioning surface 12 can be reduced, thus simplifying the structure of the cylinder block 10. The positioning surface 12 preferably includes the three planes 12a, 12b, and 12c in the example shown in FIG. 3. Alternatively, as shown in FIG. 4A, the positioning surface 12 may be composed of two planes 12a and 12b.

FIG. 1 shows an example where the cylinder block 10, the cylinder liner 20, and the crankcase 30 are separate pieces. Alternatively, the cylinder liner 20 and the crankcase 30 may be integrally formed as shown in FIG. 4B, or the cylinder block 10 and the crankcase 30 may be integrally formed as shown in FIG. 4C.

In the case where the cylinder liner 20 and the crankcase 30 are separate pieces as shown in FIG. 1 or FIG. 4C, replacement of the cylinder liner 20 when the cylinder liner 20 has abraded is facilitated.

In the case where the cylinder liner 20 and the crankcase 30 are integrally formed as shown in FIG. 4B, or the cylinder block 10 and the crankcase 30 are integrally formed as shown in FIG. 4C, the number of parts can be reduced, whereby the number of assembly steps and hence the production cost can be reduced.

Furthermore, when the cylinder block 10 and the crankcase 30 are separate pieces as shown in FIG. 1 or FIG. 4A, it becomes possible to form the cylinder block 10 from a material having a smaller specific gravity than that of the crankcase 30, thus enabling a further mass reduction of the internal combustion engine 100.

FIG. 1 and FIGS. 4A and 4B show exemplary constructions where the seal surface 11 is provided on the cylinder block 10. Alternatively, as shown in FIG. 4C or FIG. 5, a seal surface 21 having a seal groove 21a formed therein may be provided on the cylinder liner 20.

Note that, in the structures shown in FIG. 4C and FIG. 5, the sealing member 50 is arranged so as to effect sealing at the flange portion 20F of the cylinder liner 20, and thus differ from the structures of FIG. 1 and FIGS. 4A and 4B, where the sealing member 50 is arranged so as to effect sealing at a portion other than the flange portion 20F. Thus, the sealing member 50 may provide sealing for the water jacket 40 at the flange portion 20F, or at any portion other than the flange portion 20F. Note that the sealing member 50 does not need to be an O-ring, but may be any annular elastic member.

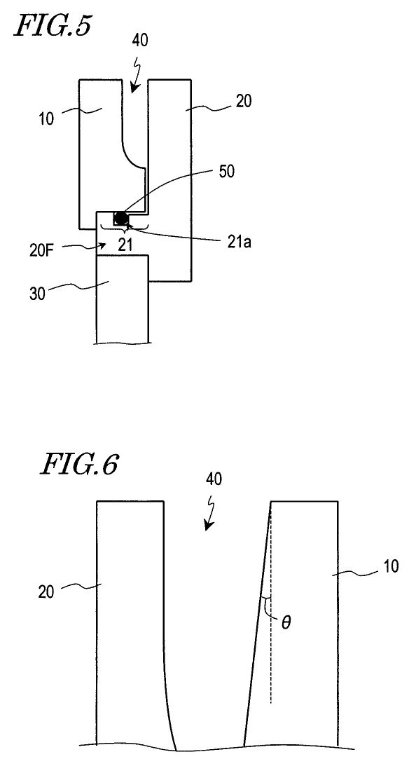

Moreover, as shown in FIG. 6, it is preferable that the side surface of the cylinder liner 20 facing the water jacket 40 has a tapered shape so as to be tilted from the cylinder axis direction. When the side surface of the cylinder liner 20 has a tapered shape, the cylinder liner 20 can be prevented from coming into contact with the coated surface 14 to cause peeling of the coating when press-fitting the cylinder liner 20 onto the cylinder block 10. The taper angle θ may be about 0.5° to about 1.5°, for example.

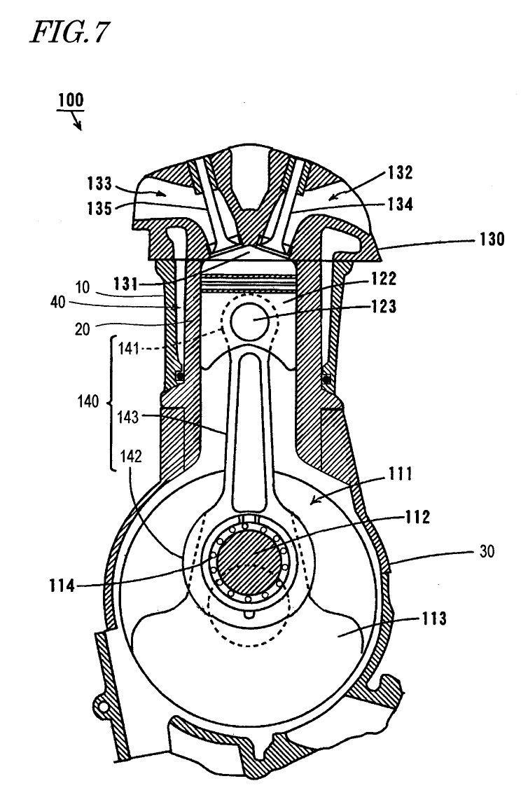

FIG. 7 shows an exemplary overall structure of the internal combustion engine 100. The internal combustion engine 100 includes a crankcase 30, a cylinder block 10, and a cylinder head 130.

A crankshaft 111 is accommodated within the crankcase 30. A crankpin 112 and a crank web 113 are provided for the crankshaft 111.

A cylinder liner 20 is fitted onto the cylinder block 10, which is provided above the crankcase 30, and a piston 122 is provided so as to be capable of reciprocating within the cylinder liner 20.

A cylinder head 130 is provided above the cylinder block 10. Together with the piston 122 and the cylinder liner 20, the cylinder head 130 defines a combustion chamber 131. An intake valve 134 for supplying fuel-air mixture into the combustion chamber 131 is provided in an intake port 132 of the cylinder head 130, and an exhaust valve 135 for performing evacuation of the combustion chamber 131 is provided in an exhaust port 133.

The piston 122 and the crankshaft 111 are linked via a connecting rod 140. The connecting rod 140 is composed of a small end 141 and a big end 142, as well as a rod portion 143 which links the two. A piston pin 123 is inserted in a through hole in the small end 141 of the connecting rod 140, and the crankpin 112 is inserted in a through hole in the big end 142, whereby the piston 122 and the crankshaft 111 are linked to each other. Roller bearings 114 are provided between the inner peripheral surface of the through hole of the big end 20 and the crankpin 112.

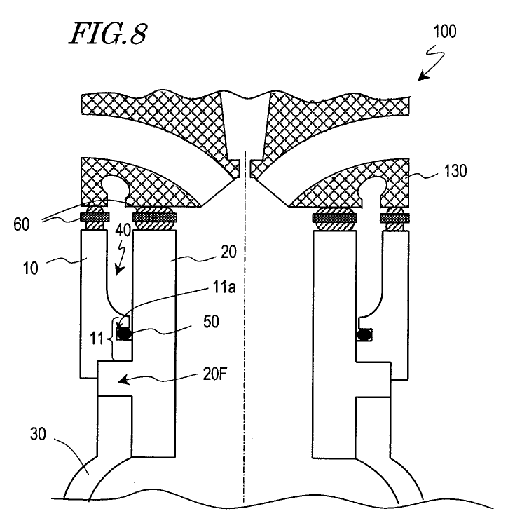

Now, with reference to FIG. 8, a preferable fastening structure for the cylinder head 130 will be described. As shown in FIG. 8, the cylinder head 130 is provided above the cylinder block 10 and the cylinder liner 20, via a gasket 60.

The cylinder head 130 is fastened to the cylinder block 20 by suitable fastening members (not shown) such as bolts, for example. Thus, from the cylinder head 130, the cylinder block 10 and the cylinder liner 20 receive a stress which is ascribable to the fastening force of the fastening members, via the gasket 60.

It is often the case that the cylinder block 10 is formed of a material whose mechanical strength is lower than that of the material of the cylinder liner 20. For example, a magnesium alloy may be used as the material of the cylinder block 10 from the standpoint of weight reduction, and an aluminum alloy may be used for as the material of the cylinder liner 20 from the standpoint of abrasion resistance. In this case, the magnesium alloy material of the cylinder block 10 has a lower mechanical strength than does the aluminum alloy material of the cylinder liner 20. Therefore, it is preferable that the stress which is applied from the cylinder head 130 to the cylinder block 10 (force applied per unit area) is smaller than the stress which is applied from the cylinder head 130 to the cylinder liner 20.

Note that the stress applied to the cylinder block 10 being smaller than the stress applied to the cylinder liner 20 means that the cylinder block 10 is held more loosely than is the cylinder liner 20, so that the cylinder block 10 may become more susceptible to the vibrations during operation. However, in the internal combustion engine 100 according to the present preferred embodiment, the cylinder block 10 and the cylinder liner 20 are spaced apart from each other in between the sealing member 50 and the water jacket 40. Therefore, even if the cylinder block 10 receives some vibrations during operation, friction is unlikely to occur between the coated surface 14 and the cylinder liner 20, and peeling of the coating is also unlikely to occur.

In order to ensure that the stress applied to the cylinder block 10 is smaller than the stress applied to the cylinder liner 20, for example, the thickness of the gasket 60 in a portion located between the cylinder block 10 and the cylinder head 130 and thickness of the gasket 60 in a portion located between the cylinder liner 20 and the cylinder head 130 may be adjusted.

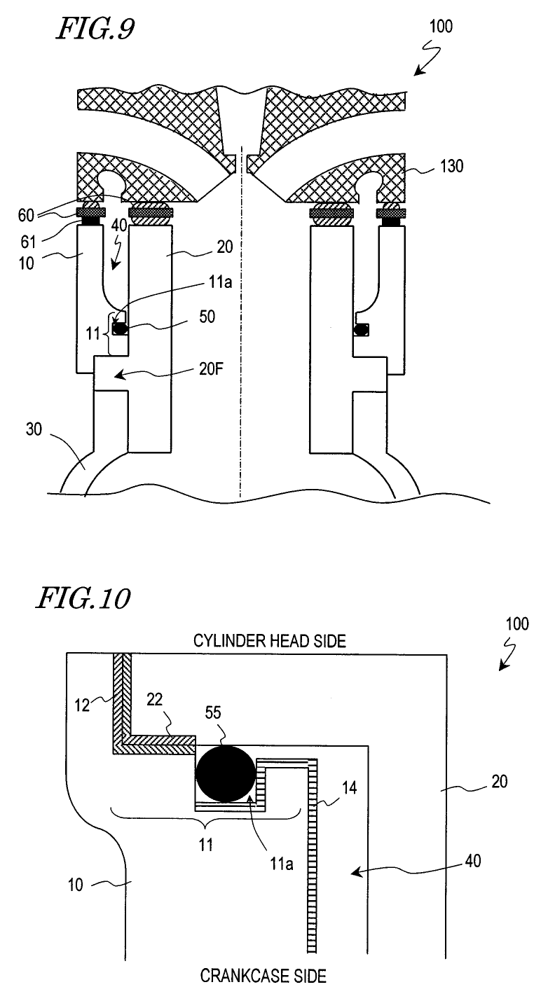

Since the gasket 60 is located near the combustion chamber, the gasket 60 is preferably formed of a material having a high thermal resistance (e.g., stainless steel). In the case where the gasket 60 and the cylinder block 10 are formed of different kinds of metals, it may be preferable to provide a further gasket composed of a resin in order to prevent electrolytic corrosion therebetween. For example, as shown in FIG. 9, in order to prevent electrolytic corrosion between a gasket 60 which is formed of a stainless steel and a cylinder block 10 which is formed of a magnesium alloy, a resin gasket 61 may be provided between the stainless steel gasket 60 and the cylinder block 10. In this case, using as the material of the gasket 61 a resin which has a lower elastic modulus than that of the stainless steel composing the gasket 60 will also help to ensure that the stress applied to the cylinder block 10 is smaller than the stress applied to the cylinder liner 20.

Although FIGS. 1 to 9 exemplify preferred embodiment constructions in which the positioning surfaces 12 and 22 are located at the crankcase 30 side of the water jacket 40, the present invention is not limited thereto. As shown in FIG. 10, the positioning surfaces 12 and 22 may be provided at the cylinder head 130 side of the water jacket 40.

In the construction shown in FIG. 10, the sealing member 50 and the positioning surfaces 12 and 22 are located at the cylinder head 130 side of the water jacket 40. In such a construction, too, since the positioning surfaces 12 and 22 are provided on the opposite side of the sealing member 50 from the water jacket 40, the cylinder block 10 and the cylinder liner 20 which are formed of respectively different metal materials can be fitted together with a high precision, while suppressing electrolytic corrosion. Note that a further sealing member (not shown) is provided between the water jacket 40 and the crankcase 30 in the construction shown in FIG. 10. However, since the positioning surfaces 12 and 22 provided at the cylinder head 130 side are responsible for the positioning between the cylinder block 10 and the cylinder liner 20, it is not necessary to provide a positioning surface between the further sealing member and the crankcase 30.

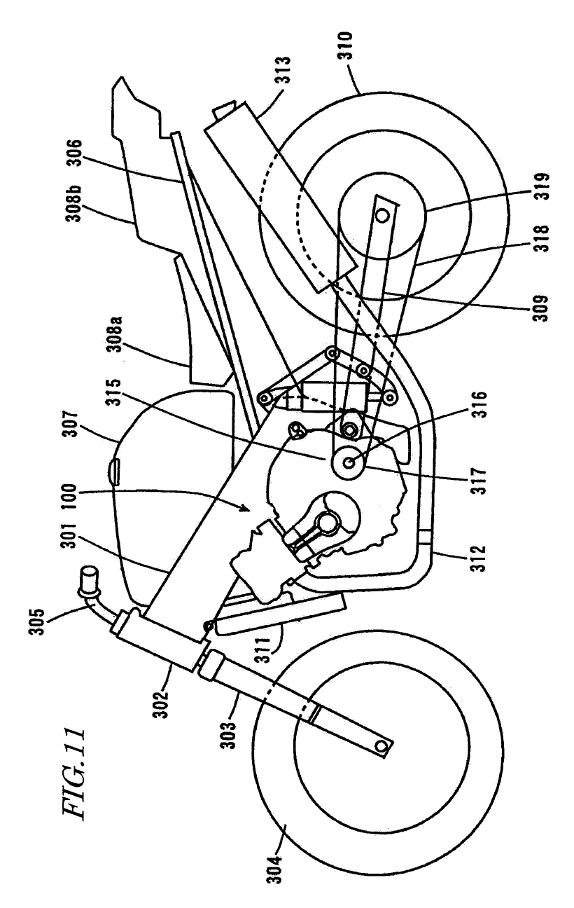

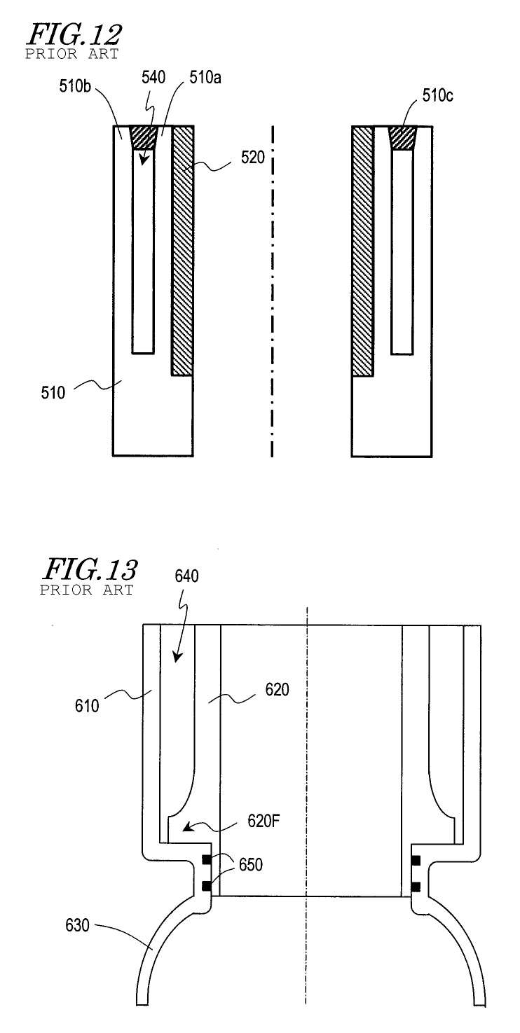

FIG. 11 shows a motorcycle which incorporates the internal combustion engine 100 shown in FIG. 7.

In the motorcycle shown in FIG. 11, a head pipe 302 is provided at the front end of a body frame 301. To the head pipe 302, a front fork 303 is attached so as to be capable of swinging in the right-left direction of the vehicle. At the lower end of the front fork 303, a front wheel 304 is supported so as to be capable of rotating.

A seat rail 306 is attached at an upper portion of the rear end of the body frame 301 so as to extend in the rear direction. A fuel tank 307 is provided on the body frame 301, and a main seat 308a and a tandem seat 308b are provided on the seat rail 306.

Rear arms 309 extending in the rear direction are attached to the rear end of the body frame 301. At the rear end of the rear arms 309, a rear wheel 310 is supported so as to be capable of rotating.

At the central portion of the body frame 301, the internal combustion engine 100 shown in FIG. 7 is held. A radiator 311 is provided in front of the internal combustion engine 100. An exhaust pipe 312 is connected to an exhaust port of the internal combustion engine 100, and a muffler 313 is attached to the rear end of the exhaust pipe 312.

A transmission 315 is linked to the internal combustion engine 100. Driving sprockets 317 are attached on an output axis 316 of the transmission 315. Via a chain 318, the driving sprockets 317 are linked to rear wheel sprockets 319 of the rear wheel 310. The transmission 315 and the chain 318 function as a transmitting mechanism for transmitting the motive power generated in the internal combustion engine 100 to the driving wheel.

Since the motorcycle shown in FIG. 11 incorporates internal combustion engine 100 according to the present preferred embodiment, excellent performance can be obtained. Although a motorcycle is illustrated herein, the internal combustion engine according to various preferred embodiments of the present invention can be suitably used for various types of transportation apparatuses such as automobiles (including four-wheeled automobiles), marine vessels, and aircraft.

According to various preferred embodiments of the present invention, there is provided an internal combustion engine of a wet liner type in which a cylinder block and a cylinder liner that are formed of respectively different metal materials are fitted together with a high precision, and in which electrolytic corrosion is suppressed. The internal combustion engine according to preferred embodiments of the present invention can be suitably used as a motive power source for various transportation apparatuses.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Application No. 2006-087377 filed on Mar. 28, 2006, the entire contents of which are hereby incorporated by reference.

What is claimed is:

1. An internal combustion engine comprising:
a cylinder block formed of a metal material;
a cylinder liner formed of a metal material different from that of the cylinder block, the cylinder liner being fitted onto the cylinder block;
a water jacket provided between the cylinder block and the cylinder liner and arranged to retain a coolant; and
a sealing member provided in contact with the cylinder block and the cylinder liner, the sealing member arranged to prevent leakage of the coolant from the water jacket; wherein
the cylinder block and the cylinder liner have respective positioning surfaces, each of which determines a relative position against the other;
each of the positioning surfaces is provided on an opposite side of the sealing member from the water jacket; and
the cylinder block and the cylinder liner are spaced apart from each other, in between the sealing member and the water jacket.

2. The internal combustion engine of claim 1, wherein at least one of the cylinder block and the cylinder liner have a coated surface on an opposite side of the sealing member from the positioning surfaces, the coated surface being covered with a coating.

3. The internal combustion engine of claim 1, wherein, between the sealing member and the water jacket, the cylinder block and the cylinder liner are spaced apart by a space of about 1 μm or more.

4. The internal combustion engine of claim 1, wherein the cylinder block or the cylinder liner has a seal surface having a seal groove for holding the sealing member.

5. The internal combustion engine of claim 4, wherein, between the sealing member and the water jacket, the cylinder block and the cylinder liner are spaced apart by a space of about 0.5 D or less, where D is a depth of the seal groove.

6. The internal combustion engine of claim 4, wherein a portion of the positioning surface is located within the seal surface.

7. The internal combustion engine of claim 1, wherein,
the positioning surfaces of the cylinder block and the cylinder liner include portions extending in a direction substantially parallel to a cylinder axis; and
a fitting tolerance between the portions extending in the direction substantially parallel to the cylinder axis is about 50 μm or less.

8. The internal combustion engine of claim 1, further comprising a crankcase, wherein the crankcase is a separate piece from the cylinder liner.

9. The internal combustion engine of claim 1, further comprising a crankcase, wherein the crankcase is a separate piece from the cylinder block.

10. The internal combustion engine of claim 1, wherein a side surface of the cylinder liner facing the water jacket has a tapered shape.

11. The internal combustion engine of claim 1, wherein the sealing member is an O-ring having a durometer hardness of no less than about 65 and no more than about 75.

12. The internal combustion engine of claim 1, wherein the metal material composing the cylinder block has a smaller specific gravity than that of the metal material composing the cylinder liner.

13. The internal combustion engine of claim 1, further comprising a cylinder head provided above the cylinder block and the cylinder liner via a gasket, the cylinder head being fastened to the cylinder block; wherein
a stress applied from the cylinder head to the cylinder block is smaller than a stress applied from the cylinder head to the cylinder liner.

14. A transportation apparatus comprising the internal combustion engine of claim 1.

15. A transportation apparatus according to claim 14, wherein the transportation apparatus is a vehicle.
